(19) United States
(12) Patent Application Publication
(10) Pub. No.: US 2010/0038377 A1
(43) Pub. Date: Feb. 18, 2010

(54) DEVICE AND METHOD FOR EMPTYING JARS

(75) Inventors: Jean-Pierre Pages, Sernhac (FR); Jocelyn Perisse, Lyon (FR); Pascal Vouagner, Fleurieu-Sur-Saone (FR)

Correspondence Address: Nixon Peabody LLP, P.O. Box 60610, Palo Alto, CA, 94306, US

(73) Assignee: AREVA NC, Paris (FR)

(21) Appl. No.: 12/522,906

(22) PCT Filed: Jan. 8, 2008
(86) PCT No.: PCT/EP2008/050113

§ 371 Date: Oct. 14, 2009

(30) Foreign Application Priority Data
Jan. 10, 2007 (FR) 0752611

(51) Int. Cl. B67D 7/84

(52) U.S. Cl. 222/1; 222/161; 222/196; 222/166

(57) ABSTRACT

According to the invention, a mandrel, provided with tabs for holding jars containing powders and for turning the jars upside down in order to empty them through the neck, is equipped with vibration generators for exciting the walls of the jar in order to shake off the powder masses adhering thereto. The method is much more efficient than even more energetic shock applications, and frequency scanning can further be advantageously applied. One application relates to an emptying step in methods for the production of nuclear fuel pellets by powder agglomeration.

### CROSS REFERENCE TO RELATED APPLICATIONS OR PRIORITY CLAIM

This application is a national phase of International Application No. PCT/EP2008/050113, entitled “DEVICE AND METHOD FOR EMPTYING JARS”, which was filed on Jan. 8, 2008, and which claims priority of French Patent Application No. 07 52611, filed Jan. 10, 2007.

### TECHNICAL FIELD

The object of this invention is a device and a method for emptying jars.

This invention has been devised for a nuclear fuel production line, but it could also be used in other applications when analogous conditions are met, particularly to empty recipients containing powders with poor flow characteristics.

The powders concerned in the initially envisaged application stem from nuclear fuel pellets that have been scrapped then ground and which have to be reused in the production of new pellets. This powder, known as chamotte, has the particularity of sloping and adhering to the walls of recipients used for storage and transfer, known as jars.

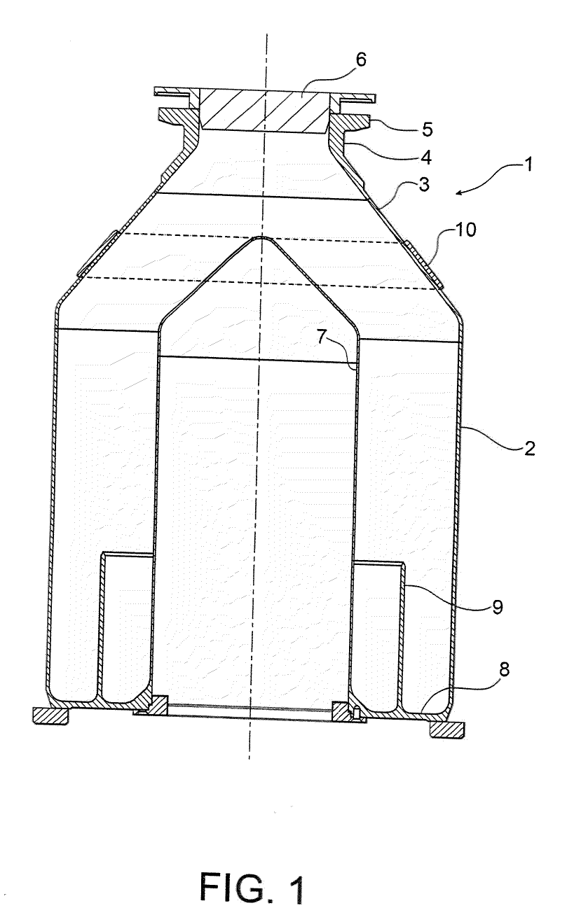

FIG. 1 represents a jar 1 of this kind. It comprises a main cylindrical body 2, an upper conical body 3 and, at the top, a neck 4 ending up in a collar 5. The jar 1 may be closed by a plug 6, which is however removed before it gets to the device of the invention. The centre of the main body 2 is hollowed out to constitute a blowing shaft 7 (so called because it houses a ventilation external to the storage of the jar 1 in order to further its cooling), the span of which extends up to the upper body 3; and the annular volume included between the main body 2 and the blowing shaft 7 bears a radiator 9 of vertical and circular rib shape, also intended for the dissipation of the heat naturally produced by the fuel filling the jar 1. The blowing shaft 7 and the radiator 9 are both linked to the remainder of the jar 1 by the bottom 8 of the main body 2. Finally, a strapping 10 forming an increased thickness on one part of the height of the upper body 3 will be noted.

When, with the plug 6 removed, the jar 1 is turned upside down, it is on the strapping 10 that shocks are applied according to the known method in order to make the powder flow out of the jar. An electromagnetic hammer is used. The results are not however sufficient on account of the adhesive nature of the powder, and it is for this reason that it has been attempted to complete the emptying of the jar 1 by applying mallet blows by hand on different parts of its surface. The results were again not satisfactory, even with shocks powerful enough to dent the jar 1. It must be admitted that the high taper of the upper body 3 and the presence of interior walls delimiting the heat dissipation shaft 7 and forming the radiator 9 significantly contribute to the adherence of the powder.

It is aimed to eliminate this drawback of poor emptying with the invention; it relates firstly to a device for emptying jars comprising a ring for mating with the jar that surrounds the neck of the jar and comprising contacting portions with the neck of the jar, characterised in that the ring comprises vibration generators 5. The application of vibrations has proved to be more efficient than the application of shocks even though the energy applied was lower and had to take place at the locations where the ring had grasped the jar, at the upper end and near to the neck, far from those locations, at the bottom of the jar, where the powder stays and adheres.

According to certain advantageous embodiment details, the vibration generators are situated on the contacting portions with the neck and are in direct contact with the neck; they are situated in a round plate pressing on a flat end face of the collar of the jar situated at an extreme portion of the neck; and they are spread out over a circumference of the round plate occupying at least one half of the circumference.

Another aspect of the invention is a method for emptying jars, comprising a step of grasping the neck of the jar by a mating ring, a step of turning the jar upside down by tilting over the ring and a step of vibrating the jar, characterised in that the vibration of the jar is assured by the ring.

One reason for the improved efficiency of the invention probably results from the possibility of excitation over a wide range of vibration frequencies, if necessary by a scanning of frequencies, so as to stimulate a larger number of fundamental modes of vibration.

The invention will now be described with reference to the following figures:

FIG. 1, already described, represents ajar and its plug,

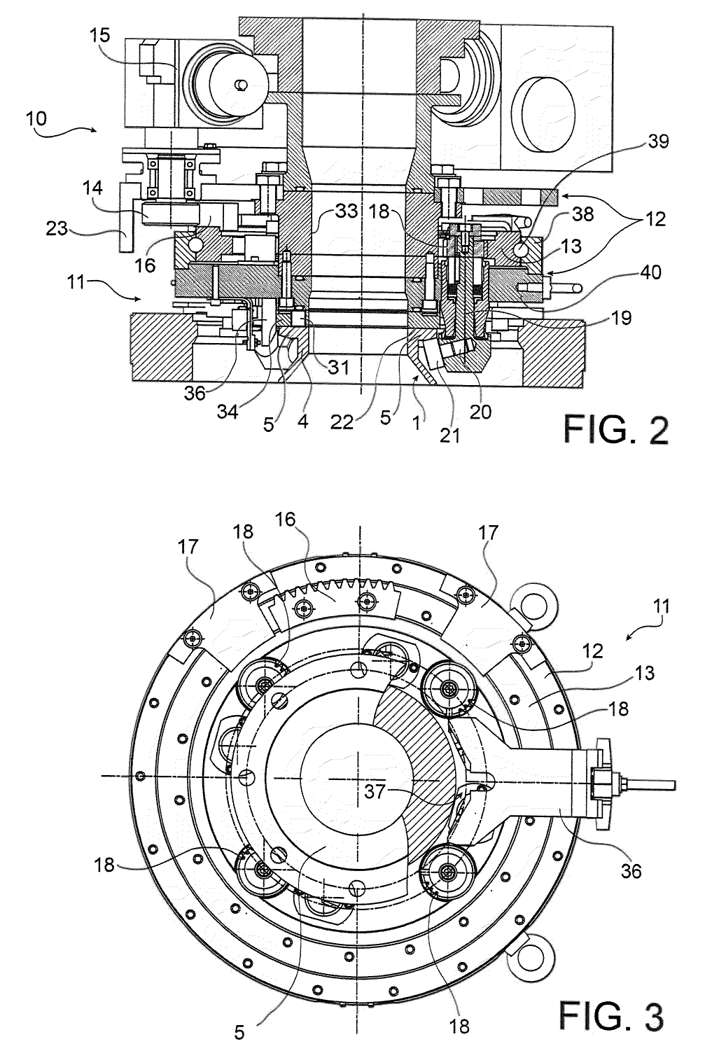

FIG. 2 illustrates the mandrel for mating with the jar in diametrical cross-section,

FIG. 3 illustrates the ring in partial view in direction of the axle,

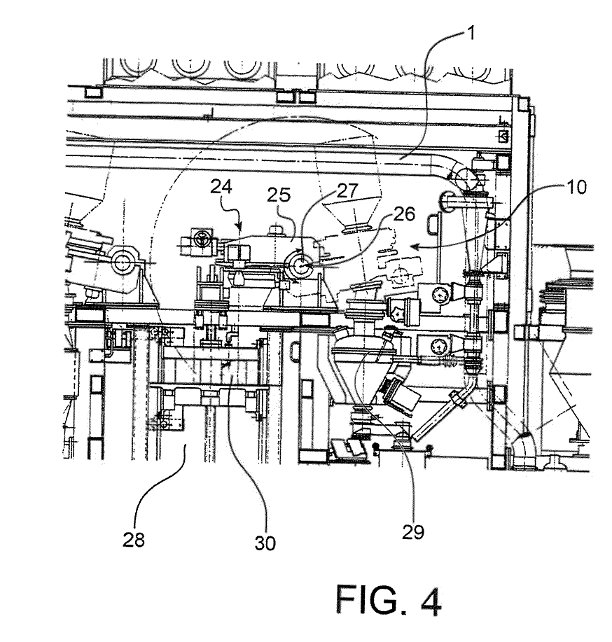

FIG. 4 partly illustrates the turning upside down and emptying device,

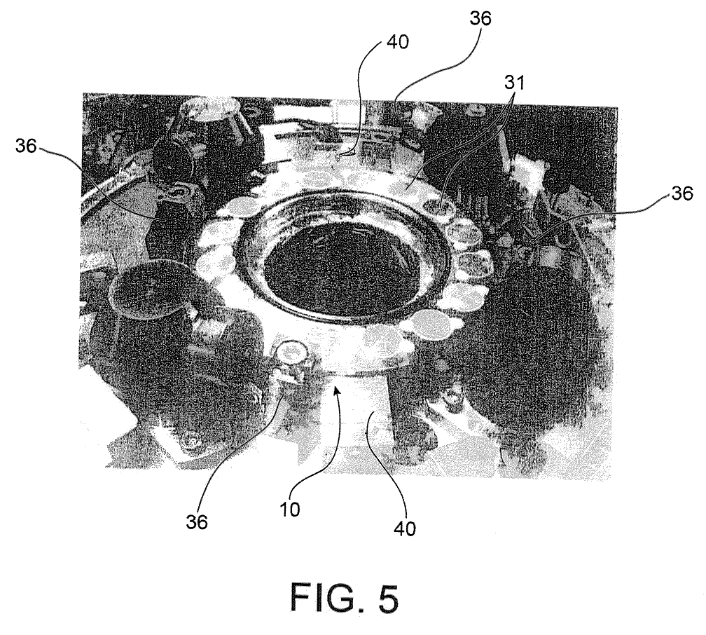

and FIG. 5 represents the layout of the vibration generators.

The apparatus used for mating, holding and turning upside down the jars 1 is represented especially in FIGS. 2 and 3. It is a mandrel 11 of general ring shape. The mandrel 11 comprises a circular, coaxial fixed part 12 and a moving part 13. The moving part 13 is turned in relation to the fixed part 12 by a pinion 14 itself driven by a motor 15 fixed to the top of the fixed part 12. The pinion 14 meshes for this purpose with a toothed sector 16 screwed onto the moving part 13. The angular travel of the moving part 13 is limited by two stop blocks 17, which the toothed sector 16 comes up against and which are assembled on the fixed part 12. The moving part 13 is an internal roller ring toothed on its internal face and which meshes with four pinions 18 spread out over a square in the ring. The fixed part 12 comprises an external roller ring 38, associated with the moving part 13 by a layer of balls 39. The roller rings are established on a main portion 40 of the fixed part 12. The pinions 18, turned by the moving part 13 when the motor 15 is actuated, themselves make turn as many axles 19 assembled in the fixed part 12 and which are co-axial to them, and which bear locking tabs 20 that extend radially with an inclination in relation to the axles 19. The tabs 20 can pass under the collar 5 of the jar 1 when it is placed under the mandrel 11, and rollers 21 that are installed at their free end roll on the lower surface of the collar 5 and press it against a mating face 22 at the bottom of the ring. An opposite movement of the mechanism separates the tabs 20 from one another and makes it possible to remove the jar 1.

In addition, there are four centering jaws 36 facing each other in pairs (visible in FIG. 5) between the tabs 20 and which can be controlled by a radial movement in the mandrel 11 to come closer to each other and tighten the collar 5 of the jar 1 by exerting a centering. For this purpose they are provided with a V-shaped impression 37 in which a part of the edge of the collar 5 rests.

The mandrel 11 is assembled on a turning apparatus 24 represented in FIG. 4, by gripping reliefs 23 that have not been represented completely. The turning apparatus 24 essentially comprises a frame 25, a motor 26 and a horizontal axle 27 turning in the frame 25 under the effect of the motor 26.

The horizontal axle 27 oscillates between a position where the mandrel 11 overhangs an inlet shaft 28 for the jars 1 and is located in the position represented in FIG. 2, with the mating face 22 below and a position where the mandrel 11 has tilted over nearly one half-turn, the jar 1 is located on it and its contents may then flow into a hopper 29 which is juxtaposed with the mandrel 11, passing through a recess 33 arranged through the mandrel 11 and on which the neck 4 is brought into contact. Nevertheless, the flow is not easy to accomplish, as has already been mentioned.

For the sake of completeness, it should be pointed out that the bottom (not represented) of the shaft 28 is occupied by ajar transport conveyor 1, and that an elevator 30 can convey the jars 1 and lift them into the shaft 28 towards the turning apparatus 24.

According to the invention, the mandrel 11 bears vibration generators 31, here sixteen in number and spread out in an exciter plate 34 occupying at least half of its extent according to FIGS. 2 and 5. These are piezoelectric vibration generators that have the advantage of having a small size and thus are able to be placed without difficulty on a mandrel 11 of small dimensions. The mating face 22 is the bottom of the plate 34, which rests on the collar 5 of the grasped jar 1, thus establishing the sealing. The vibrations are thus communicated at vibration generators 31 to the collar 5 of the jar 1 by a direct contact, the vibration generators 31 being flush with the mating face 22. It is advantageous that they have a sufficient intensity, which explains the use of a high number of vibration generators 31. They are brought into service alternately by groups (for example two groups of eight in a specific embodiment). These control means, also two in number, are secured to the fixed part 12 and bear the reference 40.

Experience and modal analysis of the jars 1 have shown that the collar 5 was the place of application of the vibrations where the jar 1 vibrated the best, whereas the vibrations and shocks inflicted elsewhere, and particularly on the strapping 10, had a much lesser effect. In addition, the vibration generators 31 make it possible to carry out frequency scannings, which excite the walls of the jar 1 according to quite different fundamental modes of vibration and which thus make it possible to better shake off everywhere the powder by making each bit of the jar 1 alternately a displacement antinode. It is aimed to excite to the resonance modes giving a high amplification coefficient between the stressed zone where the vibration generators 31 are placed, here the collar 5, and the places where the powder adheres, here near to the bottom of the jar 1. It has been found, for a particular case of a model of jars named J60, that scanning around 326 Hertz and 726 Hertz for several minutes, then starting again in the other direction, gave very good results; these frequencies correspond to the first two fundamental modes of longitudinal vibration of the jars 1 so that vibrations are spread out over all of their height and reach all of the portions where the powder adheres.

1. Device for emptying jars containing powders with poor flow characteristics, comprising a mandrel that surrounds a neck of the jar and comprising contacting portions of the neck of the jar, characterised in that the mandrel comprises vibration generators.

2. Device for emptying jars according to claim 1, characterised in that the vibration generators are situated on the contacting portions of the neck and are in direct contact with the neck.

3. Device for turning jars upside down according to claim 2, characterised in that the vibration generators are situated in a round plate pressing on a flat end face of a collar of the jar at an extreme portion of the neck.

4. Device for emptying jars according to claim 3, characterised in that the vibration generators are spread out over a circumference of the circular plate occupying at least one half of the circumference.

5. Device for emptying jars according to claim 1, characterised in that the vibration generators are piezoelectric.

6. Method for emptying jars, comprising a step of grasping a neck of the jar by a mating mandrel, a step of turning upside down the jar by tilting over the mandrel, and a step of vibrating the jar, characterised in that the vibration of the jar is assured by the mandrel.

7. Method for emptying jars according to claim 6, characterised in that the vibration of the jar is carried out by a scanning of at least one vibration frequency range.

8. Method for emptying jars according to claim 7, characterised in that it comprises two vibration frequency ranges extending around 326 Hz and 726 Hz.

9. Method for emptying jars according to claim 8, characterised in that each vibration frequency range is placed around a fundamental mode of longitudinal vibration of the jar.

10. Method for emptying jars according to claim 6, characterised in that the jar is vibrated at the neck.

11. Method for emptying jars according to claim 6, characterised in that the vibrations are of piezoelectric origin.
